(19) United States
(12) Patent Application Publication
(10) Pub. No.: US 2014/0041201 A1
(43) Pub. Date: Feb. 13, 2014

(54) HAIR BOW ATTACHMENT CLIP

(71) Applicants: George Spruill, Virginia Beach, VA (US); Shaunda Brandon, Virginia Beach, VA (US)

(72) Inventors: George Spruill, Virginia Beach, VA (US); Shaunda Brandon, Virginia Beach, VA (US)

(21) Appl. No.: 13/584,787

(22) Filed: Aug. 13, 2012

(51) Int. Cl. A45C 13/00; B23P 11/00

(52) U.S. Cl. 29/525.01; 224/269

(57) ABSTRACT

A hair bow attachment clip attaches to the exterior of a carrying bag, allowing a user to easily and securely attach and remove any hair bow, any time, for trading, sharing and displaying their hair bow collection. With current technology, it was not easy for users to attach their hair bow collection to the exterior of their carrying bags. The attachment clip of the present invention overcomes this deficiency by allowing users to easily and securely attach their hair bow collection to the exterior of their carrying bags.

### BACKGROUND OF THE INVENTION

The present invention relates to bag and bag accessories and more particularly, to a carrying bag with a bow attachment clip that allows the secure attachment of any hair bow to the bag.

Hair bows are difficult to attach to the exterior of carrying bags for trading, sharing and displaying. There are currently no other carrying bags that allow for hair bows to attach to them. Users are currently attaching hair bows to carrying bags by various crude means that often damage the hair bow and/or the carrying bag.

As can be seen, there is a need for a device for attaching a hair bow to a carrying bag securely that does not damage the hair bow and/or the carrying bag.

### SUMMARY OF THE INVENTION

In one aspect of the present invention, a carrying bag having an attachment clip assembly comprises an attachment clip; and a looped webbing looped through a first end of the attachment clip, the looped webbing attached to an exterior of the carrying bag.

In another aspect of the present invention, a carrying bag having an attachment clip assembly comprises an attachment clip; and a looped webbing looped through a first end of the attachment clip, the looped webbing attached to an exterior of the carrying bag, wherein the looped webbing is stitched to the carrying bag; from about 2 to about 5 attachment clip assemblies are attached to the exterior of the carrying bag; and the attachment clip is adapted to removably retain hair bows thereto.

In a further aspect of the present invention, a method for attaching hair bows to a carrying bag comprises connecting the hair bow to an attachment clip, the attachment clip having a looped webbing passing therethrough, and the looped webbing being attached to an exterior of the carrying bag.

These and other features, aspects and advantages of the present invention will become better understood with reference to the following drawings, description and claims.

### BRIEF DESCRIPTION OF THE DRAWINGS

FIG. 1 is a perspective view of a carrying bag having an attachment clip according to an exemplary embodiment of the present invention;

FIG. 2 is a front view of the carrying bag of FIG. 1 showing hair bows attached with the attachment clip; and

FIG. 3 is a cross-sectional view of the carrying bag and attachment clip, taken along line 3-3 of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a hair bow attachment clip that attaches to the exterior of a carrying bag, allowing a user to easily and securely attach and remove any hair bow, any time, for trading, sharing and displaying their hair bow collection. With current technology, it was not easy for users to attach their hair bow collection to the exterior of their carrying bags. The attachment clip of the present invention overcomes this deficiency by allowing users to easily and securely attach their hair bow collection to the exterior of their carrying bags.

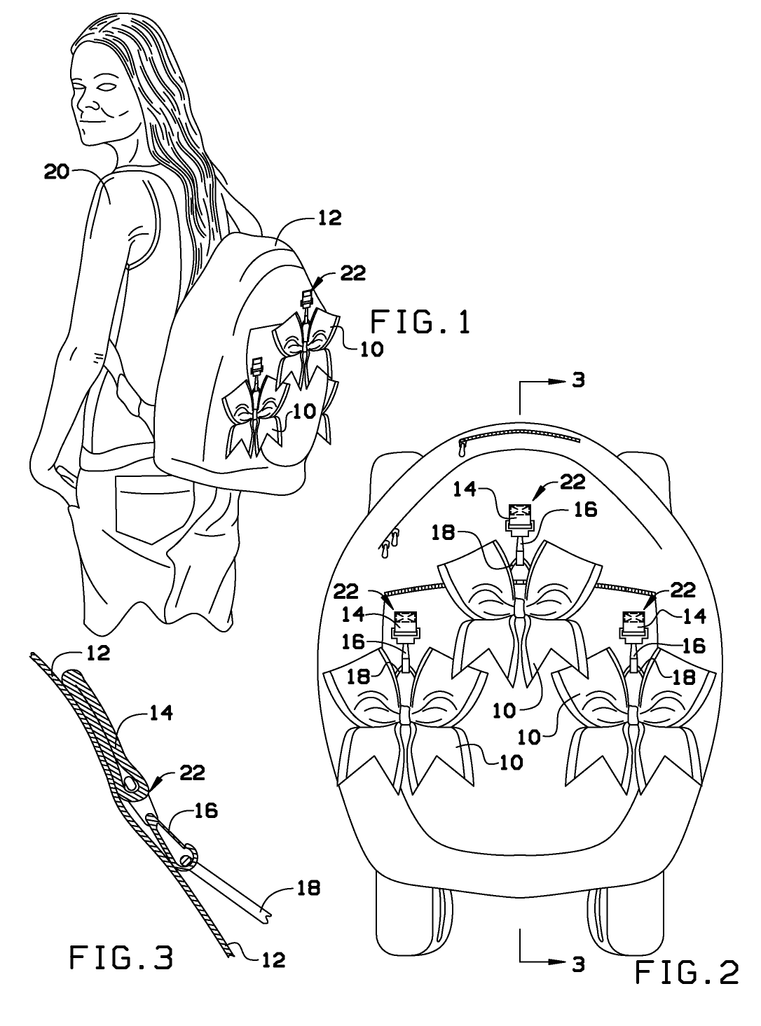

Referring to FIGS. 1 through 3, a bow 10 can be attached to a carrying bag 12 via a clip/webbing assembly 22 (also referred to as attachment clip assembly 22). The attachment clip assembly 22 can be formed from a looped webbing material 14 having a bow attachment clip 16 fitting therein. The bow attachment clip can have a first end with a loop through which the webbing material 14 can pass. A second end of the clip can include a clip mechanism that can allow a bow elastic band 18 to securely attached thereto.

The webbing material 14 can be attached to the carrying bag 12 via various means. For example, the webbing material 14 can be sewn onto the carrying bag 12. In some embodiments, the webbing material 14 can be attached by other mechanisms, such as a hook and loop fastener (such as Velcro®), snaps, buttons, or the like. In some embodiments, the carrying bag 12 can be manufactured with the attachment clip assemblies 22 pre-attached thereto. In some embodiments, from 1 to 10 attachment clip assemblies 22, typically from about 2 to 5 attachment clip assemblies, can be formed on the exterior of the carrying bag 12.

The webbing material 14 can be made from various materials, such as a tightly woven synthetic or natural webbing. The hair bow 10 can be any hair bow, typically a pre-manufactured hair bow that can be attached to and removed from the attachment clip assembly 22.

The length of the webbing material 14 can vary from about ½ inch to about 6 inches in length, typically about 1 inch in length, forming a loop.

While the above refers to a hair bow attachment clip, the attachment clip assembly of the present invention can be used for other items, permitting those items to be securely attached to and removed from any carrying bag, without damage to the item or the carrying bag.

It should be understood, of course, that the foregoing relates to exemplary embodiments of the invention and that modifications may be made without departing from the spirit and scope of the invention as set forth in the following claims.

What is claimed is:

1. A carrying bag having an attachment clip assembly, comprising:
an attachment clip; and
a looped webbing looped through a first end of the attachment clip, the looped webbing attached to an exterior of the carrying bag.

2. The carrying bag of claim 1, wherein the looped webbing is stitched to the carrying bag.

3. The carrying bag of claim 1, wherein from about 2 to about 5 attachment clip assemblies are attached to the exterior of the carrying bag.

4. The carrying bag of claim 1, wherein the attachment clip is adapted to removably retain hair bows thereto.

5. A carrying bag having an attachment clip assembly, comprising:
an attachment clip; and
a looped webbing looped through a first end of the attachment clip, the looped webbing attached to an exterior of the carrying bag, wherein
the looped webbing is stitched to the carrying bag;
from about 2 to about 5 attachment clip assemblies are attached to the exterior of the carrying bag; and
the attachment clip is adapted to removably retain hair bows thereto.

6. A method for attaching hair bows to a carrying bag, comprising:
connecting the hair bow to an attachment clip, the attachment clip having a looped webbing passing therethrough, and the looped webbing being attached to an exterior of the carrying bag.

7. The method of claim 6, further comprising stitching the looped webbing to the carrying bag.

8. The method of claim 6, further comprising attaching from about 2 to about 5 attachment clip assemblies to the exterior of the carrying bag.

9. The method of claim 6, further comprising removably retaining hair bows to the attachment clip.
